(19) United States
(12) Patent Application Publication
(10) Pub. No.: US 2025/0064277 A1
(43) Pub. Date: Feb. 27, 2025

(54) ICE SCRAPER

(71) Applicant: Cassandra MCCRACKLIN, Chicago, IL (US)

(72) Inventor: Cassandra MCCRACKLIN, Chicago, IL (US)

(21) Appl. No.: 18/940,252

(22) Filed: Nov. 7, 2024

Related U.S. Application Data
(63) Continuation-in-part of application No. 29/917,739, filed on Nov. 21, 2023.
Application No. 29/917,739 is a division of application No. 29/799,010, filed on Jul. 12, 2021, now Pat. No. D012397.

(51) Int. Cl. A47L 1/16; A47L 13/022; B60S 3/04

(52) U.S. Cl. CPC A47L 1/16; A47L 13/022; B60S 3/045

(57) ABSTRACT

A scraper is disclosed. The scraper includes a handle portion. The scraper includes a body portion coupled to the handle portion and including first openings and second openings disposed on a first exterior surface of the body portion. The scraper includes a blower disposed within the body portion. The blower is configured to output air through the first openings or the second openings. The scraper includes at least one scraping component disposed on the first exterior surface of the body portion. The at least one scraping component includes a sharp point configured to scrape a material from a surface.

### CROSS-REFERENCE TO RELATED PATENT APPLICATIONS

This application is a Continuation-in-Part of U.S. Design patent application Ser. No. 29/917,739, filed Nov. 21, 2023, which is a divisional of U.S. Design patent application Ser. No. 29/799,010 (now U.S. Design Patent No. D1012397), filed Jul. 12, 2021, the entire disclosures of which are hereby incorporated by reference herein.

### TECHNICAL FIELD

The present disclosure relates generally to an ice scraper. More specifically, the present disclosure relates to an ice scraper having electronic heating elements for providing heat.

### BACKGROUND

Scrapers may be used for removing ice, snow, and other condensation from various environments including windshields and windows. Conventionally, it may take a significant amount of time to scrape off a windshield or window using scrapers.

### SUMMARY

At least one aspect of the present disclosure relates to scraper. The scraper includes a handle portion. The scraper a body portion coupled to the handle portion, the body portion including first openings and second openings disposed on a first exterior surface of the body portion. The scraper includes a blower disposed within the body portion. The blower is configured to output air through at least one of the first openings or the second openings. The scraper includes at least one scraping component disposed on the first exterior surface of the body portion, the at least one scraping component comprising a sharp point configured to scrape a material from a surface.

At least one aspect of the present disclosure relates to a body of an ice scraper. The body includes a plurality of first openings and a plurality of second openings disposed on a first exterior surface. The body includes an internal blower configured to output air through at least one of the first openings or the second openings. The body includes at least one scraping component disposed on the first exterior surface, the at least one scraping component comprising a sharp point configured to scrape material from a surface.

At least one aspect of the present disclosure relates to a method. The method includes providing an ice scraper. The ice scraper includes a handle portion. The ice scraper includes a body portion coupled to the handle portion, the body portion including first openings and second openings disposed on a first exterior surface of the body portion. The ice scraper includes a blower disposed within the body portion. The blower is configured to output air through at least one of the first openings or the second openings. The ice scraper includes at least one scraping component disposed on the first exterior surface of the body portion, the at least one scraping component comprising a sharp point configured to scrape a material from a surface. The method includes causing air to blow out of the blower.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a perspective view of a scraper, according to an exemplary embodiment.

FIG. 2 is a front view of the scraper of FIG. 1, according to an exemplary embodiment.

FIG. 3 is a rear view of the scraper of FIG. 1, according to an exemplary embodiment.

FIG. 4 is a perspective view of a handle portion of the scraper of FIG. 1, according to an example embodiment.

FIG. 5 is a schematic diagram of the scraper of FIG. 1, according to an example embodiment.

FIG. 6 is a front view of a covering assembly for the scraper of FIG. 1, according to an example embodiment.

FIG. 7 is a front view of a covering assembly for the scraper of FIG. 1, according to an example embodiment.

FIG. 8 is an illustration of a process of using the scraper of FIG. 1, according to an example embodiment.

### DETAILED DESCRIPTION

Referring generally to the FIGURES, disclosed herein are various embodiments relating to a scraper, and particularly an ice scraper. The ice scraper is capable of blowing air, particularly warm air out, of a body of the ice scraper to facilitate melting ice, snow, or other forms of condensation. The ice scraper can include one or more scraping components having one or more sharp points or edges to scrape away the forms of condensation. The scraping components, in combination with the warm air, allows the ice scraper to remove forms of condensation more efficiently and effectively than conventional techniques. Beneficially and as described herein, the scraper of the present disclosure may facilitate relatively quicker condensation removal compared to traditional ice scrapers. This may provide a relatively more enjoyable experience for users. These and other features and benefits are described more fully herein below.

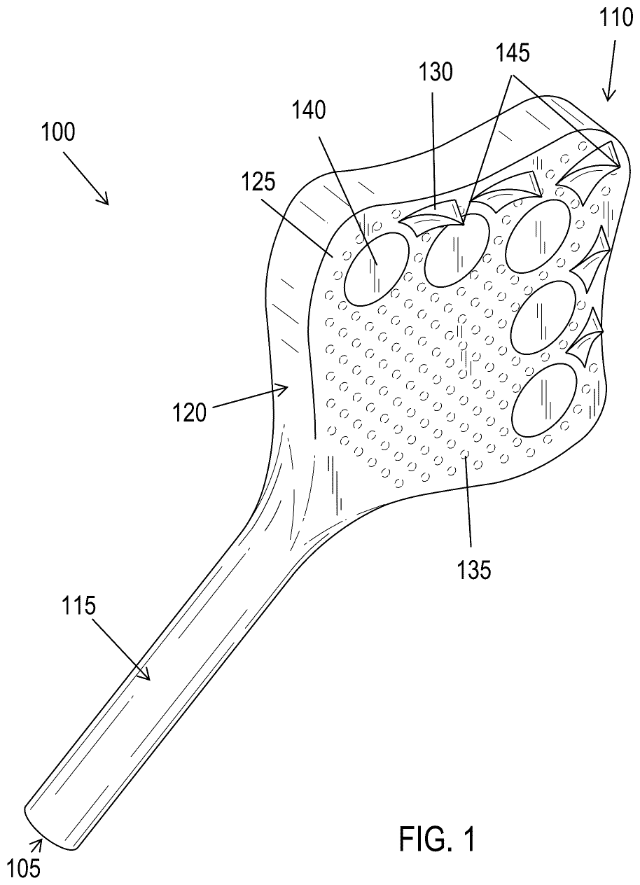

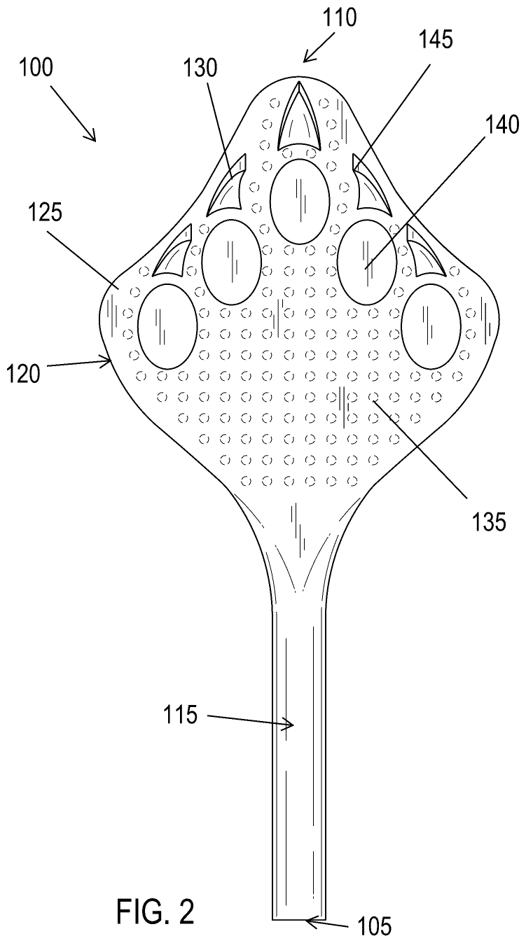

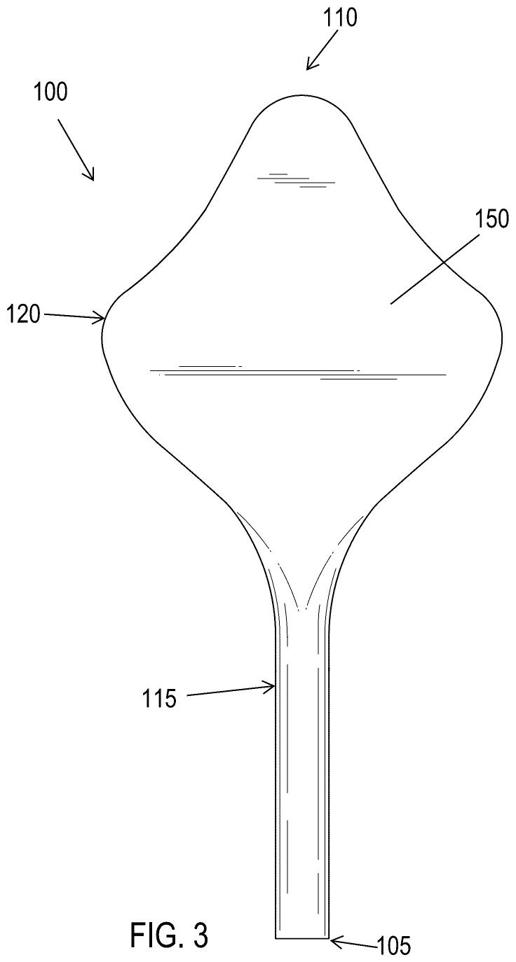

Referring now to FIGS. 1-3, various views of a scraper 100 are shown according to an example embodiment. FIG. 1 depicts a perspective view of the scraper 100, according to an example embodiment. FIG. 2 depicts a front view of the scraper 100 and FIG. 3 depicts a rear view of the scraper 100, according to an example embodiment. The scraper 100 may be or include, for example, an ice scraper or another type of scraper capable of various materials or objects, such as removing ice, snow, or other condensation off of various surfaces including, but not limited to, windows and/or windshields (or other surfaces). As shown in FIGS. 1-3, the scraper 100 extends between a first end 105 and a second end 110. The scraper 100 can include a handle portion 115 at or near the first end 105 and a body portion 120 at or near the second end 110.

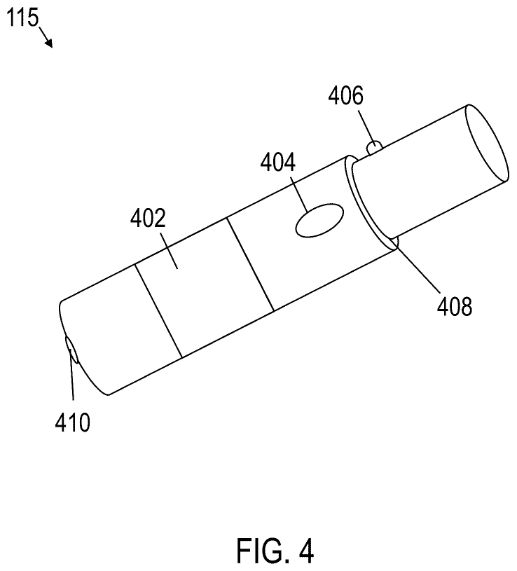

FIG. 4 depicts a perspective view of the handle portion 115, according to an example embodiment. Referring collectively to FIGS. 1-4, the handle portion 115 can include one or more portions or components capable of being held, such as a handle. For example, the handle portion 115 can include a cylindrical shape such that a user can easily hold and/or grip the handle portion 115. In some implementations, the handle portion 115 can include one or more grips 402 including, but not limited to, a sleeve or other component that at least partially surrounds the handle portion 115 for a user to grip (e.g., a rubberized portion). For example, the grip 402 may be made of a non-slip material such as rubber.

The body portion 120 can include at least one protruding scraping component 130 capable of scraping. For example, the body portion 120 can include one scraping component 130, two scraping components 130, or more scraping components 130 (e.g., five or more scraping components 130). In some implementations, the scraping components 130 can be sized or shaped like an animal claw. For example, as depicted throughout the Figures, the scraping components 130 can be shaped like a bear claw (e.g., a curved triangular prism-like shape that generally converges to a sharp, pointed tip). In other embodiments, a different shape or structure may be implemented. In some implementations, the body portion 120 can be sized or shaped like an animal paw. For example, as depicted throughout the Figures, the body portion 120 can be shaped like a bear paw.

The one or more scraping components 130 may include at least one point 145 or edge capable of scraping various types of condensation, such as ice. For example, the scraping components 130 may extend away from a front exterior surface 125 of the body portion 120 up to an outermost point 145. In some implementations, the point 145 may be formed by at least three surfaces that converge to the point 145 (e.g., a singular point). While shown in the Figures as a point 145, the point 145 may extend in a continuous line to form an edge extending at least partially in one direction (e.g., parallel a plane of the inner surface). The point 145 may facilitate scraping ice, snow or other condensation. For example, the point 145 (or edge) may be sharp enough to scrape away ice off of a surface. The scraping components 130 may be formed of various materials including, but not limited to, metals or plastics.

The body portion 120 can include at least one opening on the front exterior surface 125. For example, the body portion 120 can include one or more first openings 135 and/or one or more second openings 140. The first openings 135 can be different in shape and/or size than the second openings 140. For example, the first openings 135 may be substantially smaller than the second openings 140. The difference in size of the first openings 135 and second openings 140 can facilitate the effectiveness of fluid or gas, such as air, outputting through the second openings 140, as described herein. In some implementations, the first openings 135 and/or the second openings 140 may include a covering or screen that at least partially covers the openings. For example, the covering or screen may be sized and shaped to prevent objects from entering the openings, but allow air to flow through the openings. As described herein, the scraper 100 may include the same amount of second openings 140 as scraping components 130.

In some implementations, at least a portion of the scraper 100 can expand or extend in dimension. For example, the handle portion 115 of the scraper 100 can extend in length to elongate the length of the scraper 100. The handle portion 115 can be, for example, telescoping with two or more nested tubes 408 that can extend and retract to expand the length of the handle portion 115. The handle portion 115 can include various locking mechanisms to maintain a length of the handle portion once extended or retracted. For example, the handle portion 115 can include one or more pins 406 and holes (e.g., spring-loaded pins), clamps, levers, twists, buttons, ratchets, and/or friction locking mechanisms.

The scraper 100 can include various shapes or sizes. For example, the scraper 100 can include a length (e.g., in an axial direction of the handle portion 115) being in a range between 10cm and 150 cm, a width (e.g., across a face of the body portion 120) in a range between 5 cm and 50 cm, and a depth in a range between 1 cm and 15 cm. In some implementations, the scraper 100 can be significantly smaller or larger.

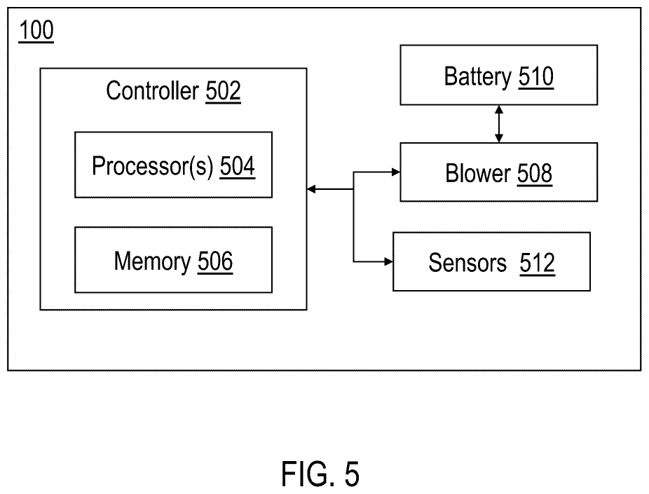

FIG. 5 depicts a schematic diagram of the scraper 100, according to an example embodiment. Referring to FIGS. 1-5, the scraper 100 can include at least one blower 508 disposed within the scraper 100. For example, the blower 508 (e.g., an air moving device such as a fan or impeller that moves air through the body and out of one or more openings) can be located in an internal hollow section of the body portion 120 (e.g., between the front exterior surface 125 and a rear exterior surface 150). The blower 508 can blow air out of the scraper 100 through at least one of the first openings 135 and/or second openings 140. In some implementations, the blower 508 can blow air out of only the first openings 135. In some implementations, the blower 508 can blow air out of only the second openings 140. In some implementations, the blower 508 can blow air out of a combination of the first openings 135 and the second openings 140. In some implementations, the blower 508 can pull air into the body portion 120 through the one or more of the first openings 135 and/or second openings 140 (e.g., to intake air). For example, the blower 508 may be configured to pull air through the first openings 135 and push air out through the second openings 140. In some implementations, the blower 508 may be configured to blow air primarily out of the second openings 140.

As depicted throughout the Figures, the scraper 100 can include at least one second opening 140 disposed adjacent to or beneath each scraping component 130 such that warm air is blown out of the second openings 140 adjacent to the scraping components 130. This configuration allows for the scraper 100 to melt and scrape away ice or snow more efficiently than conventional techniques, as the second openings 140 provide warm air at or near the positioning of the scraping components 130 scraping away the ice or snow. In some implementations, the second openings 140 may be larger in size (e.g., diameter) than a length or width of the scraping components 130, which may further facilitate increasing the speed at which the blower 508 melts ice or snow at the scraping components 130.

The blower 508 can include various components that pull in air, heat air, and output air within the scraper 100. For example, the blower can include at least one electric motor and/or fan. The motor can power the fan to pull air in and/or push air out of the blower. The blower 508 can include one or more heating components, such as a coil of wire, that is capable of heating air through the blower. The blower 508 can include various additional or alternative electrical and/or mechanical components to facilitate bringing air into the scraper 100, heating the air, and blowing air out of the scraper 100 through the one or more openings 135, 140.

In some implementations, the scraper 100 can include a controller 502 configured to control air flow from the blower 508 between a subset of the first openings 135 and/or a subset of the second openings 140. The controller 502 can include at least one processor 504 and memory 506. The processor(s) 110 may be or include any device, component, element, or hardware designed or configured to perform the various steps recited herein. For example, the processor(s) 110 may include any number of general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some implementations, the controller 502 may include a single processor 504 designed or configured to perform each of the various steps or acts recited herein. In some implementations, the controller 502 may include multiple processors 504 which are designed or configured to perform (e.g., either separately or together) each of the various steps or acts recited herein. As such, unless explicitly indicated otherwise, such as by use of a term such as “a single processor”, the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. The memory 506 may be or include any type or form of data storage device, including tangible, non-transient volatile memory and/or non-volatile memory.

The controller 502 (e.g., the one or more processors 504) may be configured to cause the blower 508 to activate to push air out of one or more first openings 135 for a first period of time, the one or more second openings 140 for a second period of time, and/or a combination of the one or more first or second openings 135, 140 for a third period of time. The controller 502 (e.g., the one or more processors 504) may be configured to control the blower 508 based on, for example, an ambient temperature (e.g., via one or more sensors 512 communicably coupled to the controller 502 and/or blower 508), a temperature or pressure of air from the blower 508, and/or from one or more user inputs to a portion of the scraper 100 (e.g., such as a button or other input located on the handle portion 115). For example, the scraper 100 can include one or more buttons, switches, dials, or other control components 404 located on an external portion of the scraper 100 for a user to interact with. The control components 404 may be communicably coupled with the controller 502 and/or with the blower 508 to cause the blower 508 to operate and/or change various characteristics of the blower 508 based on a user input to the control components 404. By way of non-limiting example, the scraper 100 can include an on/off switch, a temperature control dial, and/or a setting switch (e.g., to switch between a high temperature and low temperature and/or between the first openings 135 and the second openings 140). The controller 502 (e.g., the one or more processors 504) can activate the blower 508 responsive to a user input to the one or more control components 404.

In some implementations, the scraper 100 (e.g., the blower 508) can be battery powered. For example, the scraper 100 can include a battery 510 communicably coupled to the blower 508 to power the blower 508. In some implementations, the battery 510 can be configured such that the battery 510 includes a battery life of at least 6-12 hours or more. In some implementations, the scraper 100 can include one or more cords or charge ports 410 configured to receive an electric charge to power or charge the battery 510. In some implementations, the scraper 100 may be mains powered (e.g., powered by a connection to utility power via one or more wires).

The scraper 100 can be made from various materials. For example, the body portion of the scraper 100 may be formed of various heat-resistant plastics including, but not limited to, polyetherimide (PEI), polyether ether ketone (PEEK), polytetrafluoroethylene (PTFE), polyamide-imide (PAI), polyphenylene Sulfide (PPS), polybenzimidazole (PBI), acrylonitrile butadiene styrene (ABS), and/or various other types of plastics. Such materials facilitate allowing the blower 508 to output warm air out of the openings 135, 140 without damaging or melting a portion of the scraper 100.

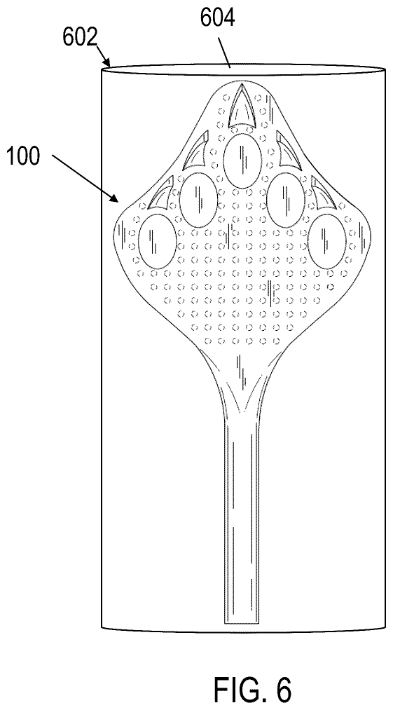

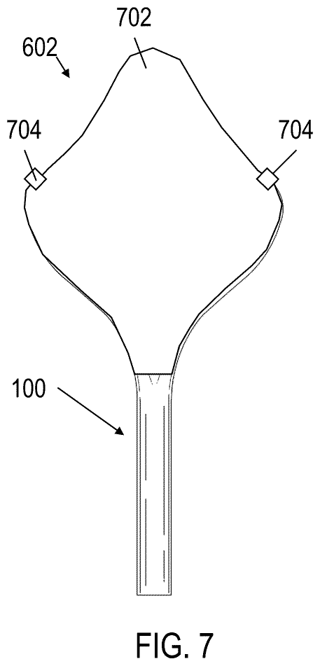

FIG. 6 and FIG. 7 depict front views of covering assemblies for the scraper 100, according to example embodiments. In some implementations, the scraper 100 can be at least partially housed or covered by a casing 602. For example, the scraper 100 can include a casing 602 that can receive the entire scraper 100 or a portion of the scraper 100, such as the body portion 120. Referring to FIG. 6, in some implementations, the casing 602 may include a bag, case, or other component configured to house the entire scraper 100 (e.g., both the handle portion 115 and the body portion 120). For example, the casing 602 can include at least one opening 604 configured to receive the scraper 100. Referring to FIG. 7, in some implementations, the casing 602 can include a cover that couples with the front exterior surface 125 of the body portion 120 to cover the scraping components 130. For example, the casing 602 can include a cover body 702 and/or one or more fasteners 704 such as a clasp, tab, or clamp, that can snap onto or otherwise couple to a portion of the scraper 100. The cover body 702 may include one or more soft materials or protruding materials configured to engage with the scraping components 130 of the scraper 100.

Referring to FIGS. 1-7, in use, a user can grip the scraper 100 by the handle portion 115 and/or by the grip 402 provided on the handle portion 115. The user can scrape away ice, snow, or other condensation by moving the scraper 100 in a motion such that the one or more scraping components 130 (e.g., at the sharp point 145) contact the ice, snow, or other condensation to scrape the condensation away. The sharp points 145 of the scraping components 130 allow the scraper 100 to more easily scrape away at stubborn condensation, such as ice. The user can press a switch or other control component 404 on the handle portion 115 (or another portion of the scraper 100) to activate the blower 508. The blower 508 can cause air (e.g., warm air) to expel out of at least one of the second openings 140 and/or the first openings 135 to facilitate melting any snow or ice near the scraping components 130. The use of warm air in combination with the scraping components 130 allows for removing snow or ice more easily and quickly than conventional techniques. The user can extend or retract the handle portion 115 to reach various different areas of snow or ice via the telescoping mechanism. When done, the user can place the scraper 100, or a portion of the scraper 100, into a casing 602 (e.g., housing, cover, or case) for the scraper 100 such that the openings 135, 140 and/or scraping components 130 are covered when not in use.

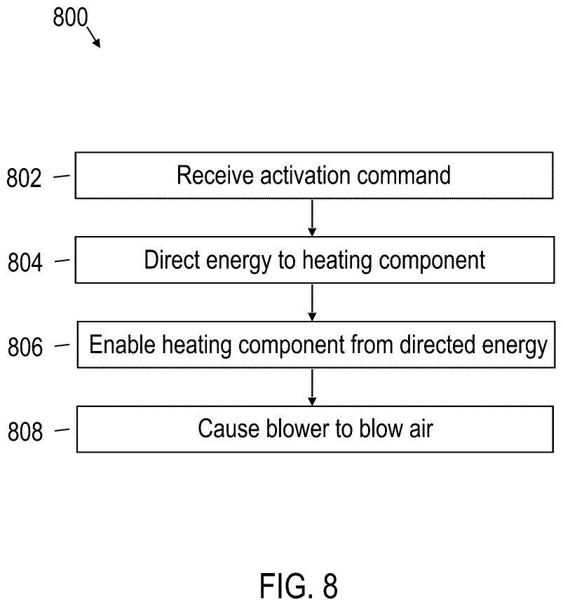

FIG. 8 depicts a method 800 of using the scraper 100, according to an example embodiment. The method 800 can include providing the scraper 100 and/or the blower 508 including one or more components described herein. The method 800 can include receiving an activation command, as depicted in act 802. For example, the controller 502 can receive one or more inputs to the control components 404 including a signal indicating to cause the blower 508 to blow air, or adjust another characteristic of the blower 508. The method 800 can include directing energy to a heating component of the blower 508, as depicted in act 804. For example, as described herein, the heating component can include a coil wire or other components configured to heat air. The method 800 can include enabling the heating component from the directed energy, as depicted in act 806. For example, the heating component can cause air within the blower 508 to become heated. The method 800 can include causing, via the controller 502, the blower 508 to blow warm air out of at least the second openings 140, as depicted in act 808. For example, the blower 508 can activate responsive to a user input to the control component 404 (e.g., button or switch) or other input to the scraper 100 to cause the blower 508 to blow warm air from the heating component out of at least one of the first openings 135 or second openings 140. The method 800 can include scraping, by one or more of the scraping components 130, condensation such as ice, snow, or other condensation. For example, movement of the scraper 100 can cause the sharp points 145 of the scraping components 130 to scrape the condensation away from a surface.

In some implementations, a user can scrape away ice, snow, or other condensation by moving the scraper 100 in a motion such that the one or more scraping components 130 (e.g., at the sharp point 145) contact the ice, snow, or other condensation to scrape the condensation away. The combination of the scraping components 130 and the warm air from the blower 508 out of the second openings 140 and/or the first openings 135 may facilitate removing condensation in an efficient manner as compared to conventional techniques, as described herein.

At least one of the second openings 140 can be disposed adjacent to or beneath each scraping component 130 such that warm air is blown out of the second openings 140 adjacent to the scraping components 130. This configuration allows for the scraper 100 to melt and scrape away ice or snow more efficiently than conventional techniques, as the second openings 140 provide warm air at or near the positioning of the scraping components 130 scraping away the ice or snow. In some implementations, the second openings 140 may be larger in size (e.g., diameter) than the first openings 135 and/or than a length or width of the scraping components 130, which may further facilitate increasing the speed at which the blower 508 melts ice or snow at the scraping components 130.

The hardware and data processing components (such as the controller) used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the scraper as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A scraper, comprising:
a handle portion;
a body portion coupled to the handle portion, the body portion including first openings and second openings disposed on a first exterior surface of the body portion;
a blower disposed within the body portion, the blower configured to output air through at least one of the first openings or the second openings; and
at least one scraping component disposed on the first exterior surface of the body portion, the at least one scraping component comprising a sharp point configured to scrape a material from a surface.

2. The scraper of claim 1, wherein the first openings are smaller in size than the second openings.

3. The scraper of claim 1, wherein the blower is battery powered.

4. The scraper of claim 1, wherein at least a portion of the body portion is comprised of a heat-resistant plastic.

5. The scraper of claim 1, wherein the handle portion comprises a telescoping mechanism to extend or retract in length.

6. The scraper of claim 1, wherein the blower is configured to intake air through the first openings and output air through the second openings.

7. The scraper of claim 1, wherein at least one of the second openings is disposed adjacent to the at least one scraping component.

8. The scraper of claim 1, wherein the handle portion includes a button configured to control at least one characteristic of the blower responsive to a user input.

9. The scraper of claim 1, wherein the handle portion comprises at least one grip.

10. The scraper of claim 1, further comprising a casing configured to at least partially cover the body portion of the scraper.

11. A body of an ice scraper, comprising:
a plurality of first openings and a plurality of second openings disposed on a first exterior surface;
an internal blower configured to output air through at least one of the first openings or the second openings; and
at least one scraping component disposed on the first exterior surface, the at least one scraping component comprising a sharp point configured to scrape material from a surface.

12. The body of claim 11, wherein the first openings are smaller in size than the second openings.

13. The body of claim 11, wherein the internal blower is battery powered.

14. The body of claim 11, further comprising at least one heat-resistant plastic portion.

15. The body of claim 11, wherein the internal blower is configured to intake air through the first openings and output air through the second openings.

16. The body of claim 11, wherein at least one of the second openings is disposed adjacent to the at least one scraping component.

17. A method, comprising:
providing a material scraper, comprising:
a handle portion;
a body portion coupled to the handle portion, the body portion including first openings and second openings disposed on a first exterior surface of the body portion;
a blower disposed within the body portion, the blower configured to output air through at least one of the first openings or the second openings; and
at least one scraping component disposed on the first exterior surface of the body portion, the at least one scraping component comprising a sharp point configured to scrape a material from a surface; and
causing air to blow out of the blower.

18. The method of claim 17, wherein the first openings of the body portion are smaller in size than the second openings of the body portion.

19. The method of claim 17, wherein the blower is battery powered.

20. The method of claim 17, wherein at least a portion of the body portion is comprised of a heat-resistant plastic.
